(19) United States
(12) Patent Application Publication
(10) Pub. No.: US 2025/0270859 A1
(43) Pub. Date: Aug. 28, 2025

(54) VEHICLE DOOR HANDLE DEVICE

(71) Applicants: AISIN CORPORATION, Kariya (JP); TOYOTA JIDOSHA KABUSHIKI KAISHA, Toyota-shi (JP)

(72) Inventors: Yusuke KONDO, Kariya-shi (JP); Kazuki TAKENAKA, Kariya-shi (JP); Tetsuya NAGASAKI, Nagoya-shi (JP)

(73) Assignees: AISIN CORPORATION, Kariya (JP); TOYOTA JIDOSHA KABUSHIKI KAISHA, Toyota-shi (JP)

(21) Appl. No.: 19/018,913

(22) Filed: Jan. 13, 2025

(30) Foreign Application Priority Data
Feb. 26, 2024 (JP) 2024-026560

(51) Int. Cl. E05B 85/10

(52) U.S. Cl. CPC E05B 85/10

(57) ABSTRACT

A vehicle door handle device includes a guide member and a latch release lever. The guide member includes a concave portion into which a user can insert his or her finger from a vehicle outer side. The latch release lever switches a door lock device from a latching state to an unlatching state by moving from an initial position to an actuation position relative to the guide member. An inner peripheral surface of the concave portion includes an inner peripheral surface formation portion located on a vehicle inner side of a vehicle-outer-side surface of the vehicle door and located at an end portion of the concave portion on one side in a front-rear direction, and faces to a side substantially opposite to the one side in the front-rear direction. The latch release lever forms at least a part of the inner peripheral surface formation portion.

### CROSS REFERENCE TO RELATED APPLICATIONS

This application is based on and claims priority under 35 U.S.C. § 119 to Japanese Patent Application 2024-026560, filed on Feb. 26, 2024, the entire content of which is incorporated herein by reference.

### TECHNICAL FIELD

This disclosure generally relates to a vehicle door handle device.

### BACKGROUND DISCUSSION

The vehicle door handle device disclosed in WO2019/120599A1 (Reference 1) includes an operation member (button: taster) rotatably attached to a frame, and a microswitch (mikroschalters) that is actuated by a movement of the operation member. A user can open a vehicle door by inserting his or her hand into a concave portion on the frame, and rotating the operation member and then actuating the microswitch.

Further, the vehicle door handle device disclosed in Reference 1 includes a latch release lever (emergency operation lever: notbetatigungshebels). The latch release lever is a member used for opening the vehicle door when the vehicle door cannot be opened by use of the operation member due to an abnormality or the like in a control device. The latch release lever is configured to be movable between an initial position (ruheposition) and an actuation position (betatigungsposition). A user can open the vehicle door by hooking his or her finger onto the latch release lever through the concave portion on the frame and pulling out the latch release lever. In principle, the latch release lever is used only for opening the vehicle door in an emergency, and is not used at a normal time.

In the vehicle door handle device disclosed in Reference 1, the initial position of the latch release lever is a position at which a vehicle-outer-side surface of the latch release lever becomes flush with the frame of the door handle device. In this configuration, the latch release lever is noticeable (particularly, a front end portion (edge) of the latch release lever is noticeable), and thus, it is feared that a user may mistakenly recognize the latch release lever as the operation member to be normally used for opening the vehicle door. The noticeable latch release lever impairs an aesthetic appearance of the door handle device.

A need thus exists for a vehicle door handle device, which is not susceptible to the drawback mentioned above.

### SUMMARY

A vehicle door handle device according to this disclosure is attached to a vehicle door including a door lock device that is switchable between a latching state of not allowing the vehicle door to be opened and an unlatching state of allowing the vehicle door to be opened. The vehicle door handle device includes a casing and a latch release lever. The casing is open on a vehicle outer side, and includes a concave portion into which a user can insert his or her finger from a vehicle outer side. The latch release lever is attached to the casing in such a way as to be movable between an initial position and an actuation position. The latch release lever is linked to the door lock device in such a way as to switch the door lock device from the latching state to the unlatching state by moving from the initial position to the actuation position. An inner peripheral surface of the concave portion includes an inner peripheral surface formation portion that is located on a vehicle inner side of a vehicle-outer-side surface of the vehicle door and that is located at an end portion of the concave portion on one side in a front-rear direction of the vehicle door. The inner peripheral surface formation portion faces to a side substantially opposite to the one side in the front-rear direction of the vehicle door. The latch release lever forms at least a part of the inner peripheral surface formation portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematical view illustrating a configuration of a vehicle door to which a vehicle door handle device according to an embodiment of this disclosure is applied;

FIG. 2 is a perspective view illustrating a state where the vehicle door handle device according to the embodiment of this disclosure is attached to the vehicle door;

FIG. 3A is a perspective view of the vehicle door handle device according to the embodiment of this disclosure;

FIG. 3B is a perspective view of the vehicle door handle device according to the embodiment of this disclosure;

FIG. 4A is an exploded view of the vehicle door handle device according to the embodiment of this disclosure;

FIG. 4B is an exploded view of the vehicle door handle device according to the embodiment of this disclosure;

FIG. 5A is an exploded view of the vehicle door handle device according to the embodiment of this disclosure;

FIG. 5B is an exploded view of the vehicle door handle device according to the embodiment of this disclosure;

FIG. 6 is a sectional view of the vehicle door handle device according to the embodiment of this disclosure;

FIG. 7 is a sectional view of the vehicle door handle device according to the embodiment of this disclosure; and

FIG. 8 is a sectional view of the vehicle door handle device according to the embodiment of this disclosure.

### DETAILED DESCRIPTION

The following describes an embodiment of this disclosure with reference to the drawings. In each drawing, a front side of a vehicle to which a door handle device is applied is indicated by the arrow Fr, a rear side of the vehicle is indicated by the arrow Rr, an outer side (hereinafter, referred to as “vehicle outer side” in some cases) in a vehicle width direction is indicated by the arrow Out, an inner side (hereinafter, referred to as “vehicle inner side” in some cases) in the vehicle width direction is indicated by the arrow In, an upper side of the vehicle is indicated by the arrow Up, and a lower side of the vehicle is indicated by the arrow Dw. In the following description, directions and mutual positional relations for the door handle device and constituents of the door handle device are based on the respective directions of the vehicle.

### Configuration Example of Vehicle Door

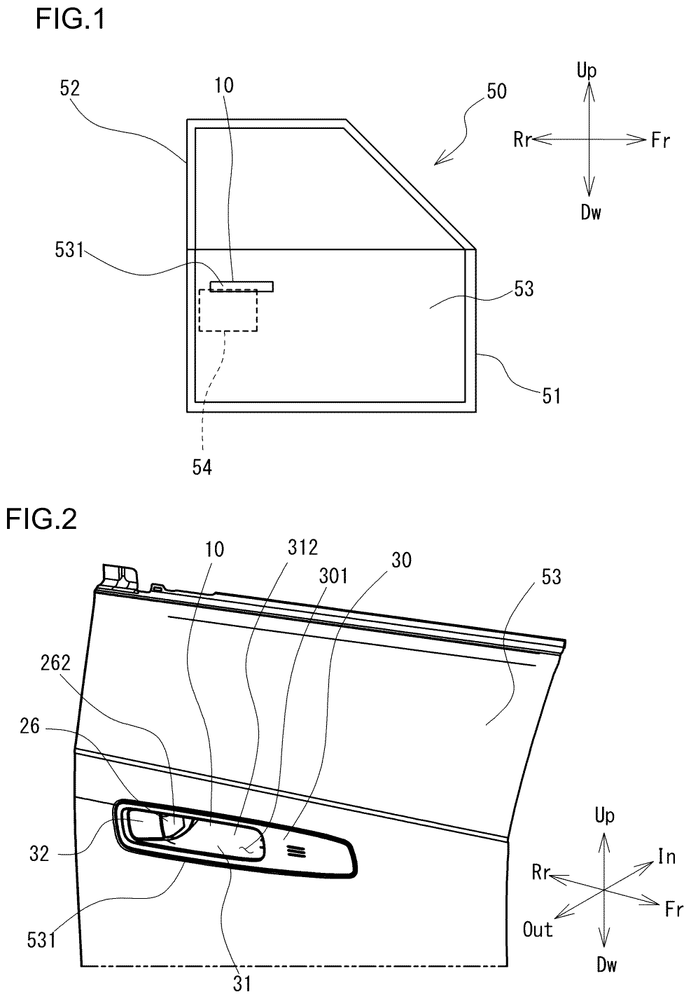

FIG. 1 is a schematic diagram illustrating a configuration example of a vehicle door 50 to which the door handle device 10 has been applied, and illustrates the vehicle door 50 viewed from a vehicle outer side. FIG. 2 is a perspective view illustrating a state in which the door handle device 10 is attached to the vehicle door 50. In this embodiment, the door handle device is applied to driver's door. The vehicle door 50 is a swing-type door that opens and closes by rotating relative to a vehicle body around a front end of the vehicle door 50. The vehicle door 50 includes a door body portion 51 constituting a lower half of the vehicle door 50, and a door sash 52 provided at an upper half of the vehicle door 50. The door body portion 51 includes an outer panel 53 constituting an outer side surface of the door body portion 51, an unillustrated inner panel fixed on an vehicle inner side of the outer panel 53, and an unillustrated resin trim fixed to an inner side surface of the inner panel and constituting an inner side surface of the door body portion 51. A panel opening 531 is provided at a position near a rear end portion of the outer panel 53 and near an upper end portion of the outer panel 53. The panel opening 531 is a through hole that has a shape elongated in a front-rear direction and that penetrates in a vehicle width direction.

A door lock device 54 as well as the door handle device 10 are arranged in the door body portion 51. The door lock device 54 is arranged on a lower side of the door handle device 10. The door lock device 54 includes a latch mechanism. The latch mechanism of the door lock device 54 is configured to be switchable between a latching state of not allowing the vehicle door 50 to be opened by each of driving force of a driving force source and manual operation of a user and an unlatching state of allowing the vehicle door 50 to be opened by each of the driving force and the manual operation. Further, the door lock device 54 is configured to be switchable between an unlocking state of allowing the latch mechanism to be switched from the latching state to the unlatching state and a locking state of not allowing the latch mechanism to be switched from the latching state to the unlatching state.

The door lock device 54 may include “a member configured to switch the latch mechanism from the latching state to the unlatching state by a downward movement of at least a part of the member”. Examples of a door lock device used as such a door lock device 54 includes one disclosed in JP2023-117102A or JP2022-079282A. The door lock devices disclosed in these publications each include an open lever that is supported by a casing of the door lock device rotatably relative to the casing. These door lock devices are each configured in such a way that rotation of the open lever in a manner of causing one end of the open lever to move downward switches the latch mechanism from a latching state to an unlatching state. Also in the following description, “a member that switches the latch mechanism from the latching state to the unlatching state by a downward movement of at least a part of the member” is referred to as “open lever”.

In addition to this, an electronic control unit (ECU) that controls the door lock device 54 is mounted on the vehicle.

As illustrated in FIG. 1 and FIG. 2, the door handle device 10 is attached at a position (near the rear end portion of the outer panel 53 and near the upper end portion of the outer panel 53) that is on a vehicle inner side of the outer panel 53 and that overlaps with the panel opening 531 when viewed in the vehicle width direction.

### Configuration of Door Handle Device

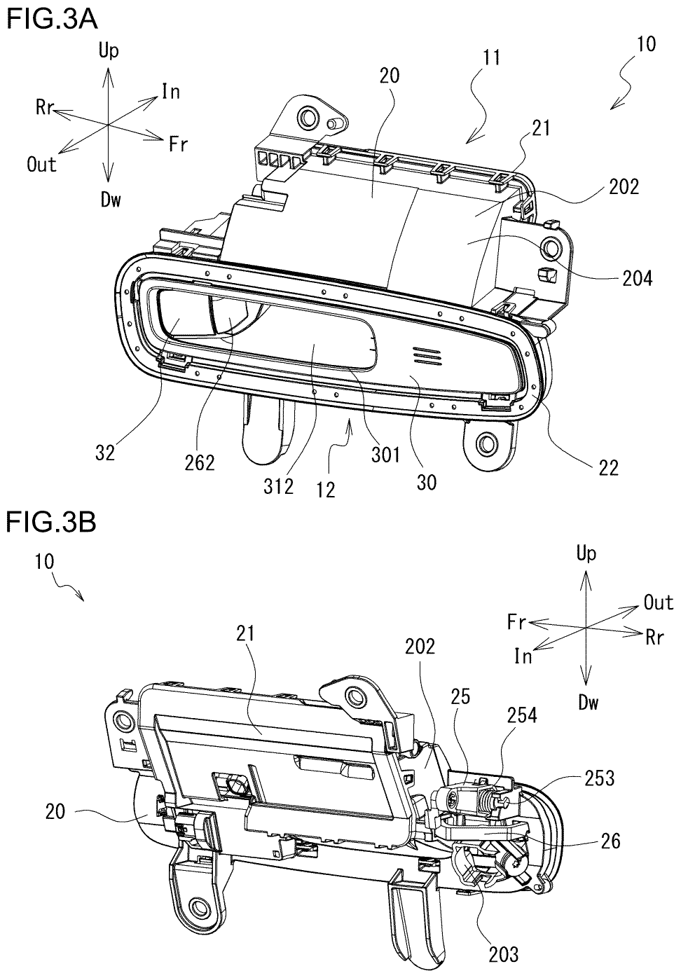

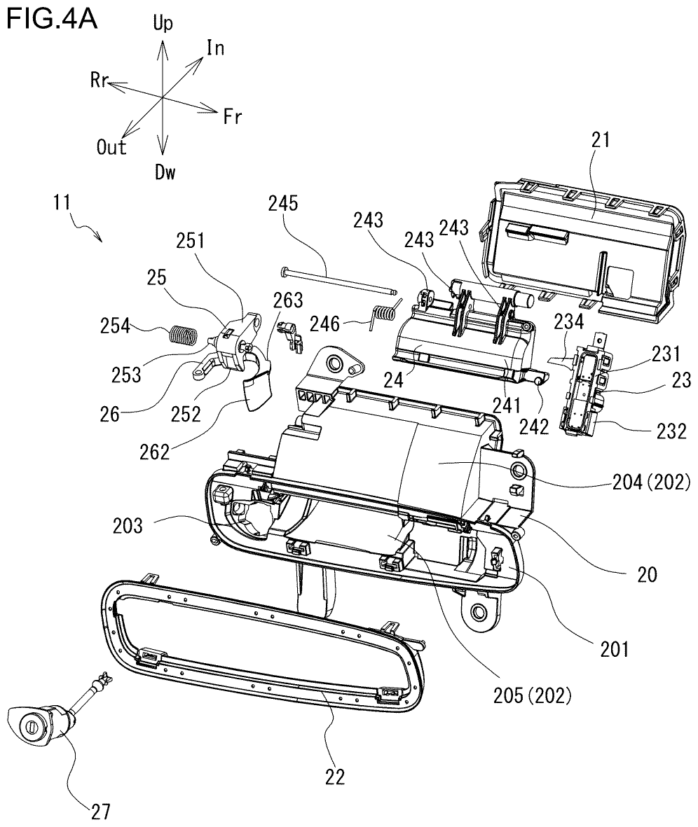

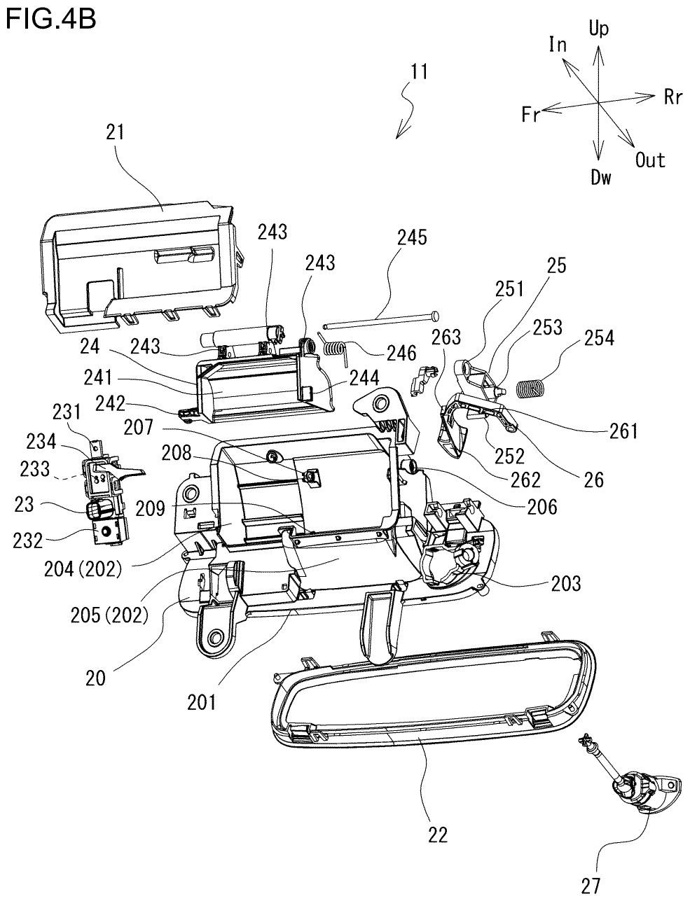

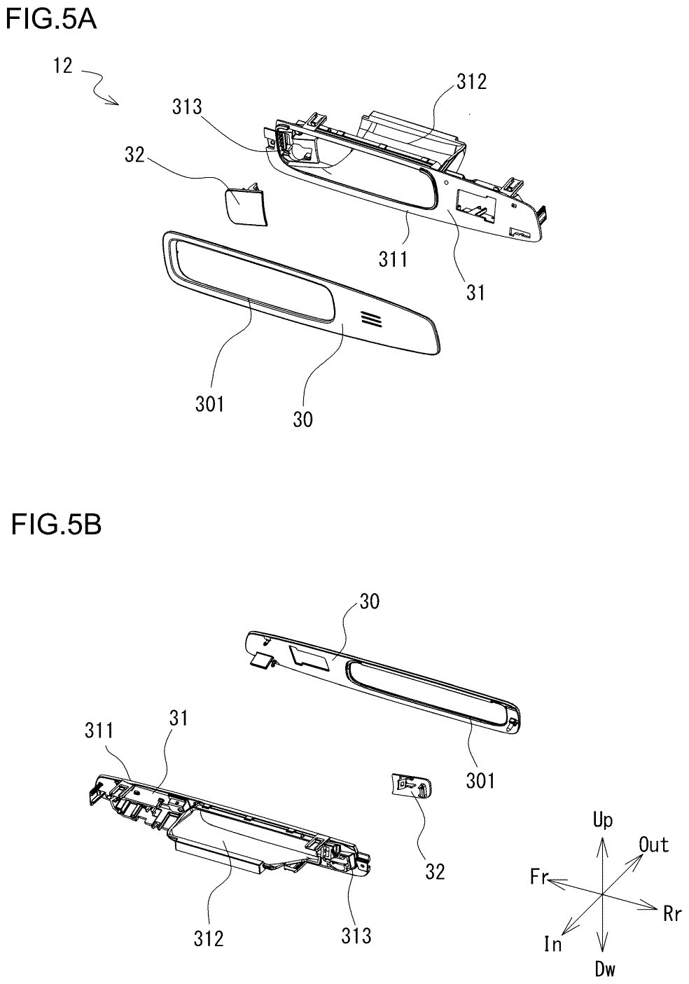

FIG. 3A and FIG. 3B are perspective views illustrating a configuration of the door handle device 10. FIG. 4A and FIG. 4B are exploded views illustrating a configuration of a case assembly 11 of the door handle device 10. FIG. 5A and FIG. 5B are exploded views illustrating a configuration of a cover assembly 12. The door handle device 10 includes the case assembly 11 attached to a vehicle inner side of the outer panel 53, and the cover assembly 12 attached to the case assembly 11 from a vehicle outer side of the outer panel 53.

The case assembly 11 includes a case body 20, an inner cover 21, an outer peripheral pad 22, a switch assembly 23, a flap 24, a bell crank 25, a latch release lever 26, and a key cylinder 27.

The case body 20 is a member that forms the casing of the door handle device 10. The case body 20 includes a frame portion 201, an accommodation portion 202, and a key cylinder attachment portion 203. The case body 20 is made of a resin material, and the above-described respective portions of the case body 20 are formed integrally with each other.

The frame portion 201 is a portion that is arranged in such a way as to overlap with the panel opening 531 when viewed in the vehicle width direction. When viewed in the vehicle width direction, the frame portion 201 has a shape elongated in the front-rear direction, and more specifically has the substantially same shape as the panel opening 531.

The accommodation portion 202 is a portion configured to be able to accommodate the flap 24, the switch assembly 23, and the guide member 31 of the cover assembly 12 which are described below. The accommodation portion 202 has a structure of a rectangular-tube shape (which can also be said as a box shape whose both vehicle-width-direction ends are open) penetrating in the vehicle width direction. An upper portion 204 (a portion corresponding to an upper plate, a front plate, and a rear plate that constitute the rectangular tube or the box) of the accommodation portion 202 is provided in such a way as to extend obliquely upward to a vehicle inner side from an upper end portion (which can also be said as an upper edge) of the frame portion 201 or from the vicinity of this upper end portion. A lower portion 205 (a portion corresponding to a lower plate that constitutes the rectangular tube or the box) of the accommodation portion 202 is provided in such a way as to extend obliquely upward to a vehicle inner side from a lower end portion (which can also be said as a lower edge) of the frame portion 201 or from the vicinity of this lower end portion.

The upper portion 204 of the accommodation portion 202 is configured to rotatably support the below-described flap 24 via a flap support shaft 245. Specifically, a rear end portion of the upper portion 204 of the accommodation portion 202 includes a rear-side shaft hole 206 as a through hole that is substantially parallel to the front-rear direction and through which the flap support shaft 245 can be inserted from a rear side. A first support shaft attachment portion 207 is provided on a vehicle-inner-side surface of the upper portion 204 of the accommodation portion 202, and has a projection shape protruding to a vehicle inner side. The first support shaft attachment portion 207 includes a front-side shaft hole 208 as a hole coaxial with the rear-side shaft hole 206 and through which (or into which) a distal end portion (front end portion) of the flap support shaft 245 can be inserted.

In addition to this, the upper portion 204 of the accommodation potion 202 includes a first stopper 209 defining a movable range of the flap 24. The first stopper 209 is a portion having a projection-shaped structure that protrudes to a vehicle inner side from the vehicle-inner-side surface of the upper portion 204 of the accommodation portion 202.

The key cylinder attachment portion 203 is a portion configured in such a way that the key cylinder 27 can be attached to the key cylinder attachment portion 203. The key cylinder attachment portion 203 is provided at or near the rear end portion of the frame portion 201 in such a way as to be on a rear side of the accommodation portion 202. The key cylinder attachment portion 203 has a cylindrical structure extending obliquely downward to a vehicle inner side from the frame portion 201.

The inner cover 21 is a member attached on a vehicle inner side of the accommodation portion 202 of the case body 20. The inner cover 21 has a substantially plate-shaped structure. The inner cover 21 attached on a vehicle inner side of the accommodation portion 202 closes a vehicle-inner-side opening of the accommodation portion 202.

The outer peripheral pad 22 is a member attached on a vehicle outer side of the frame portion 201. The outer peripheral pad 22 is a frame-shaped portion including an opening (a through hole penetrating in the vehicle width direction) that is the substantially same shape and size as those of the panel opening 531. The outer peripheral pad 22 is arranged on a vehicle inner side of the outer panel 53 in such a way as to be along an inner peripheral edge potion of the panel opening 531.

The switch assembly 23 is an assembly that includes a base member 231, a switch 232, a light source 233, and a light guide member 234. The base member 231 is a member to which the switch 232, the light source 233, and the light guide member 234 are attached. The switch 232 is a normally open type push button switch that is switched from an off state to an on state when a push button of the push button switch is pushed. The light source 233 and the light guide member 234 are configured in such a way as to be able to emit light into an internal space of a fingertip guide portion 312 of the below-described guide member 31. The switch assembly 23 is fixed to the vehicle-inner-side surface of the upper portion 204 of the accommodation portion 202 of the case body 20. The switch assembly 23 is arranged in such a way that the push button of the switch 232 faces to a vehicle inner side (in such a way as to be switched from the off state to the on state when the push button is pushed from an vehicle inner side). The switch assembly 23 is arranged on a front side of the flap 24. The switch 232 and the light source 233 of the switch assembly 23 are connected to the ECU.

The flap 24 is a member that is manually operated by a user when the user switches the latch mechanism of the door lock device 54 at the normal time from the latching state to the unlatching state. The flap 24 includes a first finger hook portion 241, a push portion 242, a second support shaft attachment portion 243, and a second stopper 244. The flap 24 is a member formed by injection molding of a resin material, and the respective portions of the flap 24 are formed integrally with each other.

The first finger hook portion 241 is a portion having a box shape (which can also be said as a shell shape open on a vehicle inner inside and on a lower side) that is open on a vehicle inner inside and a lower side and that is closed on a vehicle outer side, an upper side, a front side, and a rear side. The push portion 242 is a portion for switching a state of the switch 232 of the switch assembly 23 (described below). The push portion 242 has a rod-shaped structure that protrudes to a substantially front side from a position (or from the vicinity of this position) that is at a vehicle-inner-side end of a front end surface of the first finger hook portion 241 and that is at a lower end of the front end surface of the first finger hook portion 241. The second support shaft attachment portion 243 is provided on an upper side of the first finger hook portion 241, and is configured in such a way that the flap support shaft 245 can be attached to the second support shaft attachment portion 243. Specifically, the second support shaft attachment portion 243 has a projection-shaped structure that protrudes to an upper side from an upper surface of the first finger hook portion 241. The second support shaft attachment portion 243 includes an shaft hole that penetrates in the substantially front-rear direction and through which the flap support shaft 245 can be inserted.

The flap 24 is arranged at a position that is inside the accommodation portion 202 of the case body 20 and that is on a vehicle inner side of the upper portion 204 of the accommodation portion 202. The flap 24 is supported by the case body 20 via the flap support shaft 245 rotatably relative to the case body 20. Specifically, the flap support shaft 245 is inserted from a rear side through the shaft hole of the second support shaft attachment portion 243 of the flap 24 and the rear-side shaft hole 206 and the front-side shaft hole 208 of the accommodation portion 202. A metal round bar is used as the flap support shaft 245. Since the center line (axis) of the flap support shaft 245 is substantially parallel to the front-rear direction. the flap 24 can rotate relative to the case body 20 around the axis substantially parallel to the front-rear direction. Since the first finger hook portion 241 of the flap 24 is located on a lower side of the flap support shaft 245, the first finger hook portion 241 can reciprocate in the substantially vehicle width direction, in a pendulum manner of swinging around the flap support shaft 245.

The flap 24 is movable between an initial position and an actuation position by rotating relative to the case body 20. The initial position is a position when the first finger hook portion 241 is located at a vehicle-inner-side end of the movable range. The initial position can also be said as a position when the first finger hook portion 241 is located at the position farthest from the outer panel 53. Specifically, the initial position is a position at which the second stopper 244 of the flap 24 contacts with a vehicle-outer-side surface of the inner cover 21. The actuation position is a position when the first finger hook portion 241 is located at a vehicle-outer-side end of the movable range. Specifically, the actuation position is a position at which a vehicle-outer-side surface of the first finger hook portion 241 contacts with the first stopper 209 of the accommodation portion 202. The flap 24 located at the initial position does not push the push button of the switch 232 of the switch assembly 23 (i.e., keeps the switch 232 in the off state), and the flap 24 moved from the initial position to the actuation position pushes the push button of the switch 232 (i.e., switches the switch 232 from the off state to the on state).

The flap 24 is constantly elastically biased toward the initial position by a flap biasing member 246. Thus, the flap 24 is kept at the initial position by the biasing force of the flap biasing member 246 in a state where no external force other than that from the flap biasing member 246 is applied to the flap 24. A torsion coil spring whose both ends each include an arm is used as the flap biasing member 246. The flap biasing member 246 is arranged in such a way that the flap support shaft 245 is inserted through a coil-shaped portion of the flap biasing member 246, the one arm contacts with the case body 20, and the other arm contacts with the flap 24.

The bell crank 25 is a member that is linked to the door lock device 54 via a rod member 28 (refer to FIG. 8). The bell crank 25 is configured in such a way as to move in conjunction with the latch release lever 26 and thereby switch the latch mechanism of the door lock device 54 from the latching state to the unlatching state via the rod member 28. The bell crank 25 includes a substantially rod-shaped rod coupling portion 251 that extends in a direction substantially parallel to the vehicle width direction. a projection-shaped latch release lever engagement portion 252 that protrudes to a lower side from a vehicle-outer-side end portion of the rod coupling portion 251, and a shaft portion 253 that is provided at the vehicle-outer-side end portion of the rod coupling portion 251 and that protrudes in the front-rear direction. Thus, the bell crank 25 has a substantially “L” shape when viewed in the front-rear direction.

The bell crank 25 is arranged on a rear side of the accommodation portion 202 of the case body 20. The bell crank 25 is supported at the vehicle-outer-side end portion of the rod coupling portion 251 via the shaft portion 253 rotatably relative to the case body 20 around the axis that is substantially parallel to the front-rear direction. Thus, the bell crank 25 can rotate relative to the case body 20 in such a way that the rod coupling portion 251 moves in a substantially up-down direction and the bell crank engagement portion 261 moves in the substantially vehicle width direction. The bell crank 25 can move between an initial position and an actuation position by rotating relative to the case body 20. The initial position of the bell crank 25 is a position at which a distal end portion (vehicle-inner-side end portion) of the rod coupling portion 251 is located at an upper end of a movable range of this distal end portion and a distal end portion (lower end portion) of the latch release lever engagement portion 252 is located at a vehicle-inner-side end of the movable range of this distal end portion. The actuation position of the bell crank 25 is a position where the distal end portion of the rod coupling portion 251 is located at a lower end of the movable range of this distal end portion and the distal end portion of the latch release lever engagement portion 252 is located at a vehicle-outer-side end of the movable range of this distal end portion.

The bell crank 25 is constantly elastically biased toward the initial position by a bell crank biasing member 254. For this reason, the bell crank 25 is kept at the initial position in a state where no external force other than that of the bell crank biasing member 254 is applied to the bell crank 25. A torsion coil spring whose both ends each include an arm is used as the bell crank biasing member 254. The bell crank biasing member 254 is arranged in such a way that the shaft portion 253 of bell crank 25 is inserted through a coil-shaped portion of the bell crank biasing member 254, the one arm engages with the bell crank 25, and the other arm engages with case body 20.

The latch release lever 26 is a member that is manually operated by a user when the user switches the latch mechanism of the door lock device 54 from the latching state to the unlatching state in an emergency or the like. Examples of the emergency include a case where the latch mechanism of the door lock device 54 cannot be switched from the latching state to the unlatching state by operating the flap 24, or a case where the flap 24 cannot be manually operated. More specific examples of the emergency include a case where the ECU does not work because a charged amount of the battery is small.

The latch release lever 26 is a curved rod-shaped member having a substantially “U” shape (or a substantially “C” shape) when viewed in the up-down direction. The latch release lever 26 includes the bell crank engagement portion 261, a second finger hook portion 262, and a third stopper 263. The bell crank engagement portion 261 is provided at an intermediate position in the latch release lever 26 in the front-rear direction, and is a portion having a projection-shaped structure that protrudes to a vehicle outer side. The second finger hook portion 262 is provided at or near a front end portion of the latch release lever 26, and is a portion configured in such a way that a user can hook his or her finger on the second finger hook portion 262. The second finger hook portion 262 has a plate shape. The third stopper 263 is a portion that defines the below-described initial position of the latch release lever 26. The third stopper 263 is a portion that is provided at a position on a vehicle inner side of the second finger hook portion 262 and that has a surface facing to a vehicle inner side.

The latch release lever 26 is arranged at a position that is on a rear side of the accommodation portion 202 of the case body 20 and that overlaps with the bell crank 25 when viewed in the up-down direction, while the latch release lever 26 is oriented in such a way that an opening of the “U” shape (or “C” shape) is located on a vehicle outer side. The latch release lever 26 is supported by the case body 20 rotatably relative to the case body 20 around an axis that is substantially parallel to the up-down direction and that is at an end portion on a rear side and a vehicle outer side in the latch release lever 26. Thus, the second finger hook portion 262 and the bell crank engagement portion 261 of the latch release lever 26 can reciprocate in the substantially vehicle width direction. The latch release lever 26 can move between the initial position and an actuation position by rotating relative to the case body 20. The initial position of the latch release lever 26 is a position when the second finger hook portion 262 is located at a vehicle-inner side end of a movable range of the second finger hook portion 262. Specifically, the initial position of the latch release lever 26 is a position when the third stopper 263 of the latch release lever 26 contacts with the case body 20. The actuation position of the latch release lever 26 is a position when the second finger hook portion 262 is located on a vehicle outer side of the initial position.

The bell crank 25 and the latch release lever 26 are arranged at positions where the bell crank 25 and the latch release lever 26 overlap with each other when viewed in the up-down direction. The bell crank 25 and the latch release lever 26 are arranged in such a way that the bell crank engagement portion 261 of the latch release lever 26 is located on a vehicle inner side of the latch release lever engagement portion 252 of the bell crank 25, and the latch release lever engagement portion 252 of the bell crank 25 and the bell crank engagement portion 261 of the latch release lever 26 overlap with each other when viewed in the vehicle width direction.

When the bell crank 25 and the latch release lever 26 are arranged as described above, the latch release lever engagement portion 252 of the bell crank 25 elastically biases the bell crank engagement portion 261 of the latch release lever 26 to an vehicle inner side by the biasing force of the bell crank biasing member 254. Thus, the latch release lever 26 is constantly elastically biased to the initial position by the biasing force of the bell crank biasing member 254 transmitted via the bell crank engagement portion 261. Accordingly, the latch release lever 26 is kept at the initial position when no biasing force other than the biasing force of the bell crank biasing member 254 is applied to the latch release lever 26. When the latch release lever 26 moves from the initial position toward the actuation position, the latch release lever engagement portion 252 of the bell crank 25 is pushed to a vehicle outer side by the bell crank engagement portion 261 of the latch release lever 26, and thus moves from the initial position to the actuation position against the biasing force of the bell crank biasing member 254. In this manner, the bell crank 25 and the latch release lever 26 are mechanically linked to each other in such a way that when the latch release lever 26 is located at the initial position, the bell crank 25 is also located at the initial position, and when the latch release lever 26 is located at the actuation position, the bell crank 25 is also located at the actuation position.

The key cylinder 27 is a member that can be manually operated by a user using an adapted key. The key cylinder 27 is mechanically linked to the door lock device 54 in such a way as to be switchable between a locking state and an unlocking state. The locking state is a state of not allowing the latch mechanism of the door lock device 54 to be switched from the latching state to the unlatching state, and the unlocking state is a state of allowing the latch mechanism to be switched from the latching state to the unlatched state. A configuration of the key cylinder 27 and a configuration of the link between the key cylinder 27 and the door lock device 54 are not particularly limited, and any conventionally known configurations can be applied to these configurations. The key cylinder 27 is supported by the case body 20 by being inserted into an inside of the cylindrical shape of the key cylinder attachment portion 203.

The rod member 28 is a substantially rod-shaped member. The rod member 28 is arranged in such a way that an elongated direction of the rod member 28 is oriented in the substantially up-down direction. An upper end portion of the rod member 28 is coupled to a vehicle-inner-side end portion of the rod coupling portion 251 of the bell crank 25. A lower end portion of the rod member 28 is coupled to the open lever of the door lock device 54, or can freely engage with and freely disengage from the open lever. When the bell crank 25 moves from the initial position to the actuation position, the rod member 28 is pushed by the rod coupling portion 251 of the bell crank 25 and thus moves to a lower side, and thereby pushes down the open lever of the door lock device 54. Thereby, the latch mechanism of the door lock device 54 is switched from the latching state to the unlatching state. In this manner, the rod member 28 is mechanically linked to the bell crank 25 and the door lock device 54 in such a way as to switch the latch mechanism of the door lock device 54 from the latching state to the unlatching state when the bell crank 25 moves from the initial position to the actuation position.

The cover assembly 12 includes an exterior member 30 and a guide member 31.

The exterior member 30 is a member located on the most vehicle outer side in the door handle device 10, and forms a part of an exterior of the door handle device 10. The exterior member 30 is a plate-shaped member having the substantially same shape as that of the panel opening 531 when viewed in the vehicle width direction, and is configured to be allowed to be fitted into the panel opening 531 of the vehicle door 50. The exterior member 30 includes a fingertip insertion hole 301 into which a user can insert his or her fingertip from a vehicle outer side. The fingertip insertion hole 301 is a through hole that has a shape elongated in the front-rear direction and that penetrates in the vehicle width direction. In a state where the exterior member 30 is attached to the outer panel 53 of the vehicle door 50, the exterior member 30 is exposed to a vehicle outer side from the panel opening 531 in such a way that a vehicle-outer-side surface of the exterior member 30 is substantially flush with a vehicle-outer-side surface of the outer panel 53 of the vehicle door 50.

The guide member 31 is a member that forms the casing of the door handle device 10. The guide member 31 is a member to which the exterior member 30 is attached. The guide member 31 includes a body portion 311, a fingertip guide portion 312. and a key cover attachment portion 313. The body portion 311 is a portion that is arranged on a vehicle inner side of the exterior member 30 in such a way as to overlap with the exterior member 30. The body portion 311 has an external plate-shape that is the substantially same shape and size as those of the exterior member 30. Further, the body portion 311 includes an opening that has the substantially same shape and size as those of the fingertip insertion hole 301 of the exterior member 30.

The fingertip guide portion 312 is a portion for guiding user's fingertip inserted from the panel opening 531 into an inside (more specifically, a vehicle-inner-side surface of the first finger hook portion 241 of the flap 24 arranged in the inside of the accommodation portion 202) of the accommodation portion 202 of the case body 20. The fingertip guide portion 312 is a portion provided in such a way as to extend obliquely upward to an vehicle inner side from the vicinity of a lower end portion (the vicinity of a lower edge) of the body portion 311. The fingertip guide portion 312 has a shallow box-shaped structure (which can also be said as a tray-shaped structure) that is open on a vehicle outer side, an upper side, and a rear side and is closed on a lower side and a front side. The fingertip guide portion 312 includes an inclined surface (guide surface) that faces to an upper side and a vehicle outer side and forms a slope extending upward to a vehicle inner side.

The key cover attachment portion 313 is a portion configured to allow the key cover 32 to be attached to and detached from the key cover attachment portion 313, and is provided at a position that is on a rear side of the fingertip guide portion 312 and that is near the rear end portion of the guide member 31. The key cover attachment portion 313 is, for example, a plate-shaped portion including a through hole that penetrates in the vehicle width direction (or can be said as a frame-shaped portion that includes the opening on an inner peripheral side).

The key cover 32 is a member that is arranged on a vehicle outer side of an end surface (a surface on which a key hole is formed) of the key cylinder 27 attached to the key cylinder attachment portion 203 of the case body 20 and that thereby covers the end surface of the key cylinder 27 (in other words, hides the end surface of the key cylinder 27). The key cover 32 is a member that can be attached to and detached from the key cover attachment portion 313. For example, the key cover 32 has a flat-plate shape, and is configured to be attachable to and detachable from the key cover attachment portion 313 by a snap-fit structure.

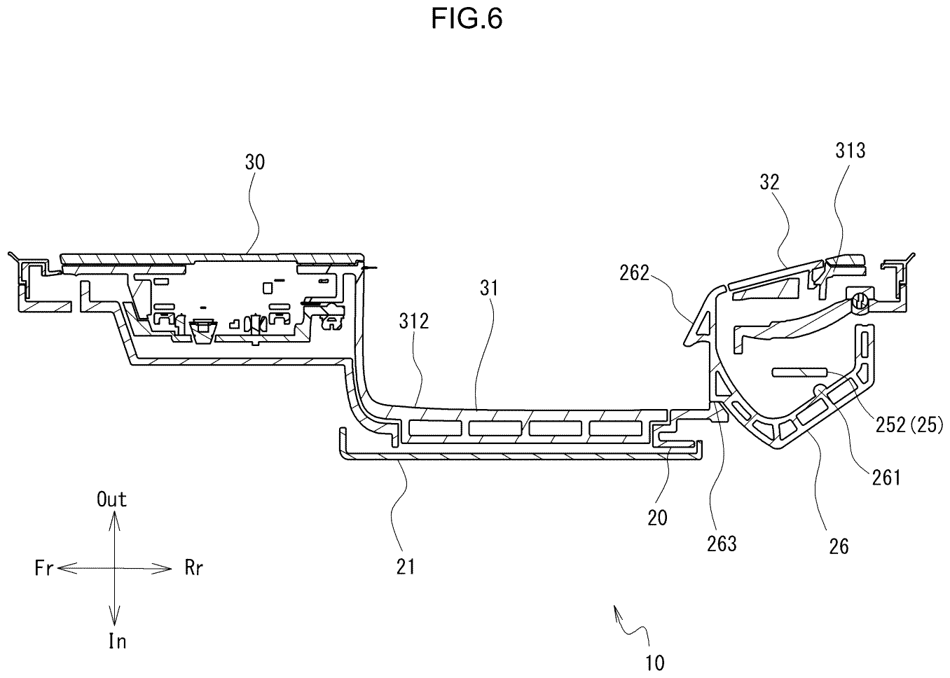

FIG. 6 a sectional view taken along a plane substantially perpendicular to the up-down direction, and illustrates a state where the door handle device 10 is attached to the outer panel 53. As illustrated in FIG. 6, in a state where the cover assembly 12 is attached to the case assembly 11, the case body 20 of the case assembly 11 and the guide member 31 of the cover assembly 12 form the casing of the door handle device 10. The casing of the door handle device 10 includes a concave portion that is formed by the fingertip guide portion 312 of the guide member 31 and the second finger hook portion 262 of the latch release lever 26, that is open to a vehicle outer side, and into which a user can insert his or her fingertip from a vehicle outer side.

The key cover 32 attached to the key cover attachment portion 313 covers a vehicle-outer-side end surface of the key cylinder 27, and is exposed to a vehicle outer side through the fingertip insertion hole 301 of the exterior member 30. The second finger hook portion 262 of the latch release lever 26 attached to the case assembly 11 is located at a position that is on a front side of the key cylinder attachment portion 203 and that is on a vehicle inner side of the key cylinder attachment portion 203. The second finger hook portion 262 of the latch release lever 26 attached to the case assembly 11 is exposed to a vehicle-outer side and to an obliquely front side through the fingertip insertion hole 301 of the exterior member 30. In this manner. the key cover 32 and the latch release lever 26 form a part of the exterior of the door handle device 10. Particularly, the second finger hook portion 262 of the latch release lever 26 is located at a rear end portion (i.e., the concave portion into which a user can insert his or her fingertip) of the fingertip guide portion 312 of the guide member 31, and closes an opening at the rear end portion of the fingertip guide portion 312. The latch release lever 26 is located at a rear end portion of the rear end portion (i.e., the concave portion into which a user can insert his or her fingertip) of the fingertip guide portion 312, and forms a rear surface portion (a surface located at the rear end portion of the concave portion and facing to a substantially front side) included in an inner peripheral surface of the concave portion and facing to a substantially front side. More specifically, a portion included in the rear surface portion and on a vehicle outer side is formed by the second finger hook portion 262. A portion (the portion on a vehicle inner side of the second finger hook portion 262) included in the rear surface portion and on a vehicle inner side is formed by a portion included in the latch release lever 26 and on a vehicle inner side of the second finger hook portion 262. The rear surface portion is an example of an inner peripheral surface formation portion in this disclosure.

When viewed in the up-down direction, a vehicle-outer-side surface of the key cover 32 and a front-side surface of the second finger hook portion 262 of the latch release lever 26 are inclined from the front-rear direction in such a way as to be more shifted to a vehicle inner side on a more front side. However, an inclination angle of the vehicle-outer-side surface of the key cover 32 made with a straight line parallel to the front-rear direction is different from that of the front-side surface of the latch release lever 26. Specifically, the angle made between the straight line parallel to the front-rear direction and the vehicle-outer-side surface of the key cover 32 is smaller than the angle made between the straight line parallel to the front-rear direction and the front-side surface of the latch release lever 26. The vicinity of a vehicle-outer-side end portion of the front-side surface of the latch release lever 26 is curved, and is connected in series to the vehicle-outer-side surface of the key cover 32 (in other words, is substantially flush with the vehicle-outer-side surface of the key cover 32). According to such a configuration, the second finger hook portion 262 of the latch release lever 26 and the key cover 32 appear to be mutually integrated (continuous). Thereby, the aesthetic appearance can be improved (the design quality can be improved).

The front-side surface of the second finger hook portion 262 of the latch release lever 26 can be said to be inclined from the vehicle width direction in such a way as to protrude to a front side on a more vehicle inner side. A vehicle-inner-side end portion of the second finger hook portion 262 of the latch release lever 26 protrudes to a front side more than a portion included in the latch release lever 26 and located on a vehicle inner side of the second finger hook portion 262. Thus, a user can hook his or her fingertip on the vehicle-inner-side end portion of the second finger hook 262 of the latch release lever 26. The vehicle-inner-side end portion of the second finger hook portion 262 and the portion located on an vehicle inner side of this vehicle-inner-side end portion in the latch release lever 26 are discontinuous with each other. However, the vehicle-inner-side end portion of the second finger hook portion 262 of the latch release lever 26 exists at a position deep from the fingertip insertion hole 301 of the guide member 31, and is thus not noticeable.

According to this embodiment, the latch release lever 26 is located at the rear end portion of the concave portion (the fingertip guide portion 312) into which a fingertip can be inserted, and forms the rear surface portion (the surface facing to a front side) in the inner peripheral surface of this concave portion so that the latch release lever 26 is less noticeable. For this reason, a user is prevented or suppressed from mistaking the latch release lever 26 for “a member normally used for unlatching operation of the vehicle door 50”. According to such a configuration, a boundary between the latch release lever 26 and other portions is less noticeable (i.e., an edge of the design portion can be less noticeable) so that the aesthetic appearance (the design quality) can be improved.

The vehicle-outer-side surface of the key cover 32 attached to the key cover attachment portion 313 is located at a position shifted from the vehicle-outer-side surface of the exterior member 30 to a vehicle inner side (in other words, at a position deeper to a vehicle inner side than the vehicle-outer-side surface of the exterior member 30). In other words, the vehicle-outer-side surface of the exterior member 30 is discontinuous with the vehicle-outer-side surface of the key cover 32 attached to the key cover attachment portion 313. With such a configuration, the vehicle-outer-side end portion of the latch release lever 26 is also located at a position shifted from the vehicle-outer-side surface of the exterior member 30 to a vehicle inner side (in other words, at a position deeper to a vehicle inner side than the vehicle-outer-side surface of the exterior member 30). Thus, an advantageous effect of making the latch release lever 26 less noticeable can be further enhanced. Further, according to such a configuration, the boundary between the latch release lever 26 and other portions is located at a position shifted from the vehicle-inner-side surface of the exterior member 30 to a vehicle inner side. For this reason, an advantageous effect of making this boundary less noticeable can be enhanced.

In this embodiment, the bell crank 25 and the latch release lever 26 are arranged at positions that are on an upper side of the key cylinder 27 and that overlap with the key cylinder 27 when viewed in the up-down direction. Such a configuration allows a dimension of the door handle device 10 in the front-rear direction to be reduced as compared with a configuration in which the bell crank 25 and the latch release lever 26 are arranged at positions shifted from each other in the front-rear direction in such a way as not to overlap with the key cylinder 27 when viewed in the up-down direction. The key cylinder 27 is arranged to be inclined in such a way that the vehicle-inner-side end portion of the key cylinder 27 is located on a lower side of the vehicle-outer-side end portion of the key cylinder 27. Thus, according to such a configuration, the bell crank 25, the latch release lever 26, and the key cylinder 27 can be arranged in such a way that the bell crank 25 and the latch release lever 26 overlap with the key cylinder 27 in the up-down direction without interfering with the key cylinder 27.

### Actuation of Door Handle Device

Next, actuation of the door handle device 10 is described. When the flap 24 is located at the initial position, the push portion 242 is separated from the switch 232 of the switch assembly 23 to a vehicle inner side, and thus, the push button of the switch 232 is not pushed. For this reason, when the flap 24 is located at the initial position, the switch 232 is kept in the off state. Meanwhile, when the flap 24 moves from the initial position toward the actuation position, the push portion 242 pushes the push button of the switch 232. Then, when the flap 24 is located at the actuation position, the push button of the switch 232 is in a state of being pushed by the push portion 242, and the switch 232 is in the on state.

A user inserts his or her fingertip into the panel opening 531 while making his or her palm face to an upper side, and hooks the fingertip on the lower end portion of the first finger hook portion 241 of the flap 24 from a lower side. Then, in this state, the user pulls the first finger hook portion 241 to a vehicle outer side so that the first finger hook portion 241 moves to a vehicle outer side against the biasing force of the flap biasing member 246. Thus, the push portion 242 moves to a vehicle outer side together with the first finger hook portion 241, and thereby pushes the push button of the switch 232 assembled in the switch assembly 23. As a result, the switch 232 is switched from the off state to the on state.

When the ECU detects that the switch 232 is switched from the off state to the on state, the ECU switches the latch mechanism of the door lock device 54 from the latching state to the unlatching state. When the door lock device 54 is in the locking state, the ECU switches the door lock device 54 to the unlocking state, and then switches the door lock device 54 to the unlatching state. The user successively pulls the first finger hook portion 241 to a vehicle outer side, and can thereby open the vehicle door 50. Then, when the user releases the fingertip from the first finger hook portion 241, the flap 24 moves to the initial position by the biasing force of the flap biasing member 246 so that the switch 232 is switched from the on state to the off state. In this manner, at the normal time, the user can open the vehicle door 50 (switch the door lock device 54 from the latching state to the unlatching state) by operating the flap 24.

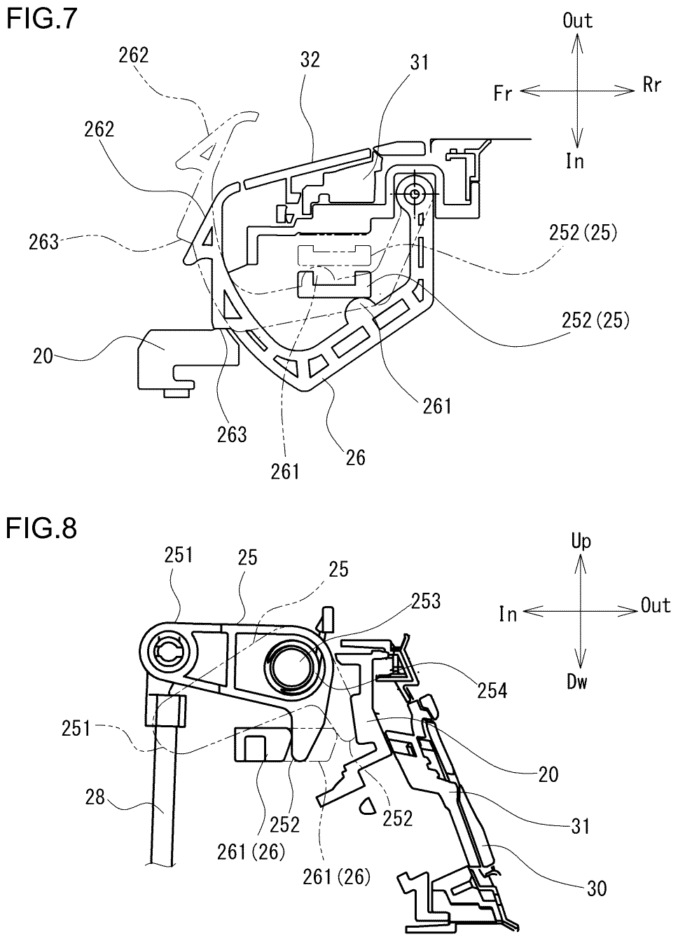

In an emergency such as a case where the ECU is not working, a user can manually operate the latch release lever 26 to thereby switch the latch mechanism of the door lock device 54 from the latching state to the unlatching state. FIG. 7 and FIG. 8 are sectional views illustrating actuation of the latch release lever 26 and the bell crank 25.

When the door lock device 54 is in the locking state, a user detaches the key cover 32, and switches the door lock device 54 from the locking state to the unlocking state by using the key and thus operating the key cylinder 27. Then, the user moves the latch release lever 26 from the initial position to the actuation position as illustrated in FIG. 7. In FIG. 7, the latch release lever 26 located at the initial position is depicted by the solid lines, and the latch release lever 26 located at the actuation position is depicted by the two-dot chain lines. At this time, the user can pull the second finger hook portion 262 out to a vehicle outer side by hooking his or her fingertip on the vehicle-inner-side end portion of the second finger hook portion 262 of the latch release lever 26.

The movement of the latch release lever 26 from the initial position to the actuation position causes the bell crank engagement portion 261 of the latch release lever 26 to push the latch release lever engagement portion 252 of the bell crank 25 to a vehicle outer side. Thereby, the bell crank 25 rotates around the shaft portion 253 and thus move from the initial position to the actuation position. as illustrated in FIG. 8, At this time, the rod coupling portion 251 of the bell crank 25 pushes the rod member 28 to a lower side. In FIG. 8, the bell crank 25 located at the initial position is depicted by the solid lines, and the bell crank 25 located at the actuation position is depicted by the two-dot chain line. Then, pushing the open lever of the door lock device 54 to a lower side by the rod member 28 causes the latch mechanism of the door lock device 54 to be switched from the latching state to the unlatching state. In this manner, the latch release lever 26 is mechanically linked to the door lock device 54 via the bell crank 25 and the rod member 28 in such a way as to switch the latch mechanism of the door lock device 54 from the latching state to the unlatching state by being moved from the initial position to the actuation position.

In this manner, the door handle device 10 is configured to allow the latch mechanism of the door lock device 54 to be switched from the latching state to the unlatching state via the rod member 28. Since the rod member 28 is less expensive than a wire, component cost of the door handle device 10 can be reduced as compared with a configuration in which the door lock device 54 is linked via the wire.

### Outline of Embodiment

(1) A vehicle door handle device 10 attached to a vehicle door 50 and including a door lock device 54 that is switchable between a latching state of not allowing the vehicle door 50 to be opened and an unlatching state of allowing the vehicle door 50 to be opened, the vehicle door handle device 10 including:
a casing (a case body 20 and a guide member 31) open on a vehicle outer side and including a concave portion (a fingertip guide portion 312) into which a user can insert his or her finger from a vehicle outer side; and
a latch release lever 26 attached to the casing (the case body 20 and the guide member 31) in such a way as to be movable between an initial position and an actuation position, the latch release lever 26 being linked to the door lock device 54 in such a way as to switch the door lock device 54 from the latching state to the unlatching state by moving from the initial position to the actuation position, wherein
an inner peripheral surface of the concave portion (the fingertip guide portion 312) includes a rear surface portion located on a vehicle inner side of a vehicle-outer-side surface of the vehicle door 50 and located at a rear end portion of the concave portion (the fingertip guide portion 312), the rear surface portion facing to a substantially front side, and
the latch release lever 26 forms at least a part of the rear surface portion.

According to this embodiment, the latch release lever 26 is located at the rear end portion of the concave portion (the fingertip guide portion 312) of the casing (the case body 20 and the guide member 31), and forms the rear surface portion that is a surface included in the inner peripheral surface of the concave portion (the fingertip guide portion 312) and facing to a front side. For this reason, the latch release lever 26 is less noticeable. Thus, with such a configuration, a user can be prevented or suppressed from mistakenly recognizing that “the latch release lever 26 is a member used for opening the vehicle door 50 at the normal time (the latch release lever 26 is a member that is normally used for opening the vehicle door 50)”. With such a configuration, the boundary between the latch release lever 26 and other portions is less noticeable (i.e., the edge of the design portion can be made less noticeable) so that the aesthetic appearance (design quality) can be improved.

(2) The vehicle door handle device 10 according to this embodiment includes:
a key cylinder 27 linked to the door lock device 54 in such a way as to be able to switch the door lock device 54 between a locking state and an unlocking state. The locking state is a state of not allowing the door lock device 54 to be switched from the latching state to the unlatching state. The unlocking state is a state of allowing the door lock device 54 to be switched from the latching state to the unlatching state, wherein
the latch release lever 26 and the key cylinder 27 overlap with each other when viewed in an up-down direction.

According to such a configuration, a dimension of the door handle device 10 in a front-rear direction can be prevented or suppressed from being increased.

(3) The vehicle door handle device 10 according to the present embodiment includes:
a bell crank 25 that is arranged to be movable between an initial position and an actuation position relative to the casing (the case body 20 and the guide member 31), and that is linked to the latch release lever 26 in such a way that when the latch release lever 26 is located at the initial position, the bell crank 25 is located at the initial position, and when the latch release lever 26 is located at the actuation position, the bell crank 25 is located at the actuation position; and
a rod member 28 that is linked to the bell crank 25 and the door lock device 54 in such a way as to switch the door lock device 54 from the latching state to the unlatching state when the bell crank 25 moves from the initial position to the actuation position.

Since the rod member 28 is a substantially rod-shaped member and is less expensive than a wire, the component cost of the door handle device 10 can be reduced as compared with a configuration in which the door lock device 54 is linked via the wire.

(4) In the vehicle door handle device 10 according to this embodiment.
the bell crank 25 is configured in such a way as to move the rod member 28 to a lower side by moving from the initial position to the actuation position.

A conventionally known door lock device is configured in such a way as to include an open lever and be switched from a latching state to an unlatching state by movement of the open lever to a lower side. The vehicle door handle device 10 according to this embodiment can be applied to a vehicle door including such a door lock device.

Although the embodiment of this disclosure is described above, this disclosure is not limited to the above-described embodiment. This disclosure can be variously modified without departing from the essence of this disclosure, and these modifications are also encompassed in the technical scope of this disclosure.

For example, the rear surface portion of the concave portion in the above-described embodiment is formed by only the latch release lever 26, but there is no limitation to such a configuration. For example, the fingertip guide portion 312 of the guide member 31 may include a portion that forms “the rear surface portion of the concave portion”, and the second finger hook portion 262 and the fingertip guide portion 312 may form “the rear surface portion of the concave portion”. In short, the latch release lever 26 may form at least a part of “the rear surface portion of the concave portion”.

The vehicle door handle device 10 in the above-described embodiment includes the key cylinder 27, but the vehicle door handle device 10 does not need to include the key cylinder 27. The switch assembly 23 in the above-described embodiment is arranged on a front side of the flap 24, but a positional relation between the flap 24 and the switch assembly 23 is not limited to that in the above-described embodiment.

A vehicle door handle device according to this disclosure is attached to a vehicle door including a door lock device that is switchable between a latching state of not allowing the vehicle door to be opened and an unlatching state of allowing the vehicle door to be opened. The vehicle door handle device includes a casing and a latch release lever. The casing is open on a vehicle outer side, and includes a concave portion into which a user can insert his or her finger from a vehicle outer side. The latch release lever is attached to the casing in such a way as to be movable between an initial position and an actuation position. The latch release lever is linked to the door lock device in such a way as to switch the door lock device from the latching state to the unlatching state by moving from the initial position to the actuation position. An inner peripheral surface of the concave portion includes an inner peripheral surface formation portion that is located on a vehicle inner side of a vehicle-outer-side surface of the vehicle door and that is located at an end portion of the concave portion on one side in a front-rear direction of the vehicle door. The inner peripheral surface formation portion faces to a side substantially opposite to the one side in the front-rear direction of the vehicle door. The latch release lever forms at least a part of the inner peripheral surface formation portion.

In the vehicle door handle device according to this disclosure, the latch release lever is located at the end portion on the one side in the front-rear direction of the vehicle door, and forms at least a part of the inner peripheral surface formation portion being a surface included in an inner peripheral surface of the concave portion and facing to the side substantially opposite to the one side. For this reason, the latch release lever is less noticeable. Thus, a user can be prevented or suppressed from mistakenly recognizing that “the latch release lever is a member to be used for opening the vehicle door at a normal time (the latch release lever is a member that is normally used for opening the vehicle door)”. With such a configuration, a boundary between the latch release lever and other portions is less noticeable (i.e., an edge of a design portion of the latch release lever can be made less noticeable), and thus the aesthetic appearance (design quality) can be improved.

In the vehicle door handle device described above, the inner peripheral surface formation portion may be located at a rear end portion of the concave portion, and may face to a substantially front side.

The vehicle door handle device described above may include a key cylinder. The key cylinder may be linked to the door lock device in such a way as to be able to switch the door lock device between a locking state and an unlocking state. The locking state is a state of not allowing the door lock device to be switched from the latching state to the unlatching state. The unlocking state is a state of allowing the door lock device to be switched from the latching state to the unlatching state. The latch release lever and the key cylinder may overlap with each other when viewed in an up-down direction.

With such a configuration, a dimension of the door handle device in a front-rear direction can be prevented or suppressed from being increased.

The vehicle door handle device described above may include a bell crank and a rod member. The bell crank may be arranged to be movable between an initial position and an actuation position relative to the casing. The bell crank may be linked to the latch release lever in such a way that, when the latch release lever is located at the initial position, the bell crank is located at the initial position, and when the latch release lever is located at the actuation position, the bell crank is located at the actuation position. The rod member may be linked to the bell crank and the door lock device in such a way as to switch the door lock device from the latching state to the unlatching state when the bell crank moves from the initial position to the actuation position.

Since the rod member is a substantially rod-shaped member and is less expensive than a wire, the component cost of the door handle device can be reduced as compared with a configuration in which the door lock device is linked via the wire.

In the vehicle door handle device described above, the bell crank may be configured in such a way as to move the rod member to a lower side by moving from the initial position to the actuation position.

A conventionally known door lock device is configured in such a way as to include an open lever and be switched from a latching state to an unlatching state by movement of the open lever to a lower side. The vehicle door handle device of the fifth aspect can be applied to a vehicle door including such a door lock device.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle door handle device to be attached to a vehicle door including a door lock device that is switchable between a latching state of not allowing the vehicle door to be opened and an unlatching state of allowing the vehicle door to be opened, the vehicle door handle device comprising:
a casing being open on a vehicle outer side and including a concave portion into which a user can insert his or her finger from a vehicle outer side; and
a latch release lever attached to the casing in such a way as to be movable between an initial position and an actuation position, the latch release lever being linked to the door lock device in such a way as to switch the door lock device from the latching state to the unlatching state by moving from the initial position to the actuation position, wherein
an inner peripheral surface of the concave portion includes an inner peripheral surface formation portion that is located on a vehicle inner side of a vehicle-outer-side surface of the vehicle door and that is located at an end portion of the concave portion on one side in a front-rear direction of the vehicle door, the inner peripheral surface formation portion facing to a side substantially opposite to the one side in the front-rear direction of the vehicle door, and
the latch release lever forms at least a part of the inner peripheral surface formation portion.

2. The vehicle door handle device according to claim 1, wherein
the inner peripheral surface formation portion is located at a rear end portion of the concave portion, and faces to a substantially front side.

3. The vehicle door handle device according to claim 1, further comprising
a key cylinder linked to the door lock device in such a way as to be able to switch the door lock device between a locking state of not allowing the door lock device to be switched from the latching state to the unlatching state and an unlocking state of allowing the door lock device to be switched from the latching state to the unlatching state, wherein
the latch release lever and the key cylinder overlap with each other when viewed in an up-down direction.

4. The vehicle door handle device according to claim 1, further comprising:
a bell crank that is arranged to be movable between an initial position and an actuation position relative to the casing, and that is linked to the latch release lever in such a way that, when the latch release lever is located at the initial position, the bell crank is located at the initial position, and when the latch release lever is located at the actuation position, the bell crank is located at the actuation position; and
a rod member that is linked to the bell crank and the door lock device in such a way as to switch the door lock device from the latching state to the unlatching state when the bell crank moves from the initial position to the actuation position.

5. The vehicle door handle device according to claim 4, wherein
the bell crank is configured in such a way as to move the rod member to a lower side by moving from the initial position to the actuation position.
